(19) United States
(12) Patent Application Publication
(10) Pub. No.: US 2018/0247301 A1
(43) Pub. Date: Aug. 30, 2018

(54) SYSTEMS AND METHODS FOR DELIVERING A VIRTUAL PAYMENT DEVICE TO AN ELECTRONIC WALLET

(71) Applicant: JPMorgan Chase Bank, N.A., New York, NY (US)

(72) Inventors: Dominick Gallo, Chicago, IL (US); Tu P. Le, Chicago, IL (US)

(21) Appl. No.: 15/908,063

(22) Filed: Feb. 28, 2018

Related U.S. Application Data
(60) Provisional application No. 62/464,654, filed on Feb. 28, 2017.

(51) Int. Cl. G06Q 20/36; G06Q 20/32; G06Q 20/34

(52) U.S. Cl. CPC G06Q 20/363; G06Q 20/204; G06Q 20/342; G06Q 20/3278

(57) ABSTRACT

Systems and methods for delivering a virtual payment device to electronic wallets are disclosed. In one embodiment, a method for delivering a virtual payment device to an electronic wallet may include receiving, from a first party, a request to issue a virtual payment device to a second party; generating the virtual payment device; and delivering the virtual payment device to an electronic wallet for the second party. In another embodiment, a method for delivering a virtual credit card to an electronic wallet may include receiving, from a first party, a request to issue a virtual credit card to a second party, the virtual credit card comprising a portion of a line of credit associated with the first party; generating the virtual credit card with the portion of the line of credit associated with the first party; and delivering the virtual credit card to an electronic wallet for the second party

### RELATED APPLICATIONS

The present application claims the benefit of U.S. Provisional Patent Application Ser. No. 62/464,654, filed Feb. 28, 2017, the disclosure of which is hereby incorporated, by reference, in its entirety.

### BACKGROUND OF THE INVENTION

### 1. Field of the Invention

The present disclosure generally relates to systems and methods for delivering a virtual payment device to an electronic wallet.

### 2. Description of the Related Art

Virtual credit cards and tokens may be used for business-to-business payments. The virtual credit cards may be generated on-demand and sent to counter-parties of clients of a financial institution by electronic mail for payment. For example, a merchant that is due payment from a client may receive the virtual credit card for that payment. The email delivery mechanism, however, is sub-optimal. For security purposes, the merchant either receives only partial account information (for example, the merchant receives half from the financial institution, and the other half is provided by the financial institution's client), or the merchants are required to use a secure email process.

### SUMMARY OF THE INVENTION

Systems and methods for delivering a virtual payment device to an electronic wallet are disclosed. According to one embodiment, in an information processing apparatus, a method for delivering a virtual payment device may include: (1) receiving, from a first party, a request to issue a virtual payment device to a second party, the virtual payment device based on an account associated with the first party; (2) generating the virtual payment device; and (3) delivering the virtual payment device to an electronic wallet for the second party.

In one embodiment, the method may further include receiving a transaction from the electronic wallet for the second party with the virtual payment device. The transaction may be conducted using RF communication (e.g., NFC).

In one embodiment, the method may further include receiving, from a point of transaction device associated with the second party, a transaction request using the virtual payment device.

In one embodiment, the virtual payment device may be a virtual credit card.

In one embodiment, the method may further include receiving at least one transaction restriction to associate with the virtual payment device. The transaction restriction may be a merchant restriction, a good/service restriction, an expiration date, a transaction number restriction, a transaction amount restriction, a geographic restriction, a time of day restriction, etc.

In one embodiment, the virtual payment device may be a virtual stored value card.

In one embodiment, the step of delivering the virtual payment device to an electronic wallet for the second party may include provisioning the virtual payment device for the electronic wallet for the second party, pushing the virtual payment device to the electronic wallet for the second party, etc.

In one embodiment, the account may be a credit account, a deposit account, etc.

According to another embodiment, in an information processing device comprising at least one computer processor, a method for delivering a virtual credit card to an electronic wallet may include: (1) receiving, from a first party, a request to issue a virtual credit card to a second party, the virtual credit card comprising a portion of a line of credit associated with the first party; (2) generating the virtual credit card with the portion of the line of credit associated with the first party; and (3) delivering the virtual credit card to an electronic wallet for the second party.

In one embodiment, the method may further include receiving a transaction from the electronic wallet for the second party with the virtual credit card.

In one embodiment, the method may further include receiving at least one transaction restriction to associate with the virtual credit card. The transaction restriction may be a merchant restriction, a good/service restriction, an expiration date, a transaction number restriction, a transaction amount restriction, a geographic restriction, a time of day restriction, etc.

In one embodiment, the step of delivering the virtual credit card to an electronic wallet for the second party may include provisioning the virtual credit card for the electronic wallet for the second party, pushing the virtual credit card to the electronic wallet for the second party, etc.

In one embodiment, the request to issue the virtual credit card to the second party may be received from an electronic wallet for the first party.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for delivering a virtual payment device to an electronic wallet according to one embodiment;

FIG. 2 depicts a method for delivering a virtual payment device to an electronic wallet to another one embodiment; and

FIG. 3 depicts a method for provisioning a virtual payment device from a first electronic wallet to a second electronic wallet according to one embodiment.

### DETAILED DESCRIPTION OF PREFERRED EMBODIMENTS

Embodiments disclosed herein may include an electronic wallet or application that may receive a virtual payment device, such as a virtual credit card. The electronic wallet may be coupled to a NFC or other point of sale-compatible payment features of the mobile device to provide a better end-to-end experience of receiving and processing of the virtual payment device. Embodiments may reduce or eliminate the need for electronic mail and provide convenience for completing the transaction on a POS device.

Embodiments may include dynamic card provisioning of the virtual payment device. In general, current electronic wallets rely on a user manually completing a series of steps to add a payment device to the user's electronic wallet. In embodiments, however, the virtual payment device may be pushed dynamically to the mobile device/wallet, without user intervention.

Embodiments may extend the use of an electronic wallet to merchants. Currently, electronic wallets are cardholder applications and are used to represent actual credit cards in the cardholder's wallet. In embodiments, merchants may be provided with a card acceptance mechanism, whereby the electronic wallet technology may be used in place of delivering or handing a physical credit card to someone as part of a transaction.

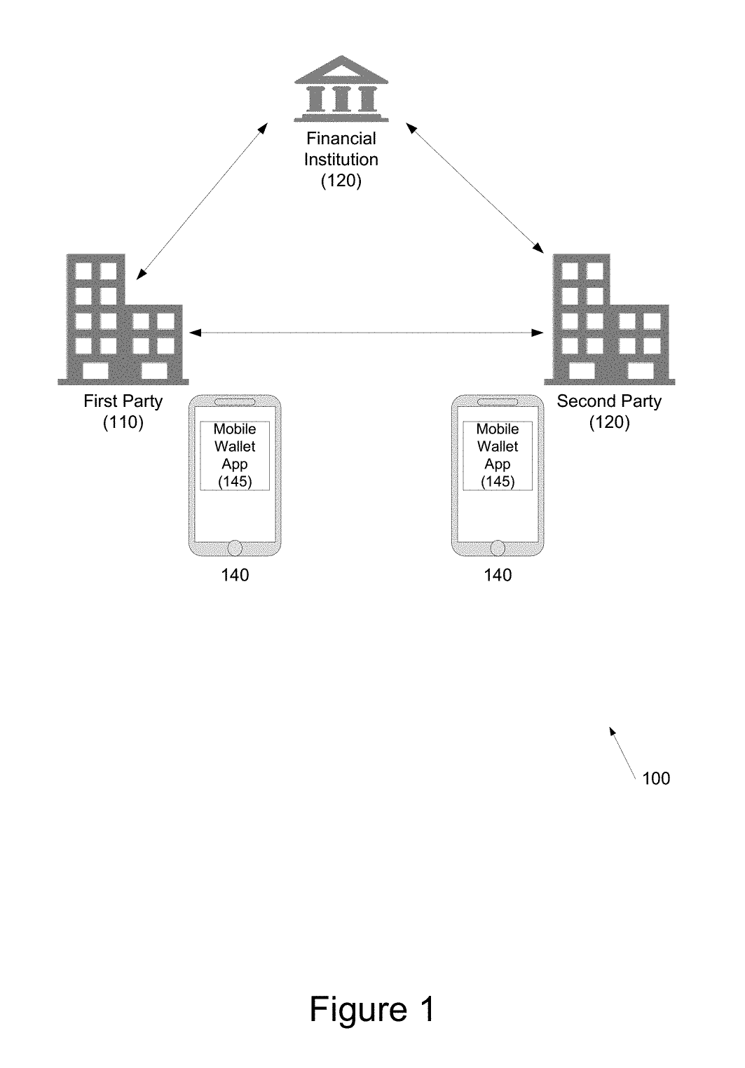

FIG. 1 depicts a system for delivering a virtual payment device to an electronic wallet according to one embodiment. System 100 may include first party 110, financial institution 120, and second party 130. Although first party 110 and second party 130 are depicted as businesses, it should be recognized that first party 110 and second party 130 may be any entity, including individuals, businesses, etc.

Financial institution 120 may be the financial institution for first party 110. For example, first party 110 may have one or more accounts (e.g., checking, savings, credit card, line of credit, etc.) with financial institution 120. Financial institution 120 may host electronic wallet application 145 that may be executed by electronic devices 140 (e.g., a smartphone, tablet computer, etc.). First party 110 and/or second party 130 may each have electronic devices 140.

In one embodiment, first party 110 may request that a virtual payment device be delivered to second party 130. In one embodiment, first party 110 may request the virtual payment device be delivered as a payment, as a gift, as part of a line of credit for first party 110, etc.

As an example of a use case, first party 110 may be an automobile insurance provider, and second party 130 may be a vehicle repair facility. Following an insurance claim, second party 130 may inform first party 110 that the repair is complete. First party 110 may then authorize financial institution 120 to issue a virtual payment device to second party 120 (e.g., for the repair amount minus the customer's deductible). Financial institution 120 may then issue the virtual payment device to an electronic wallet for second party 130 for the amount.

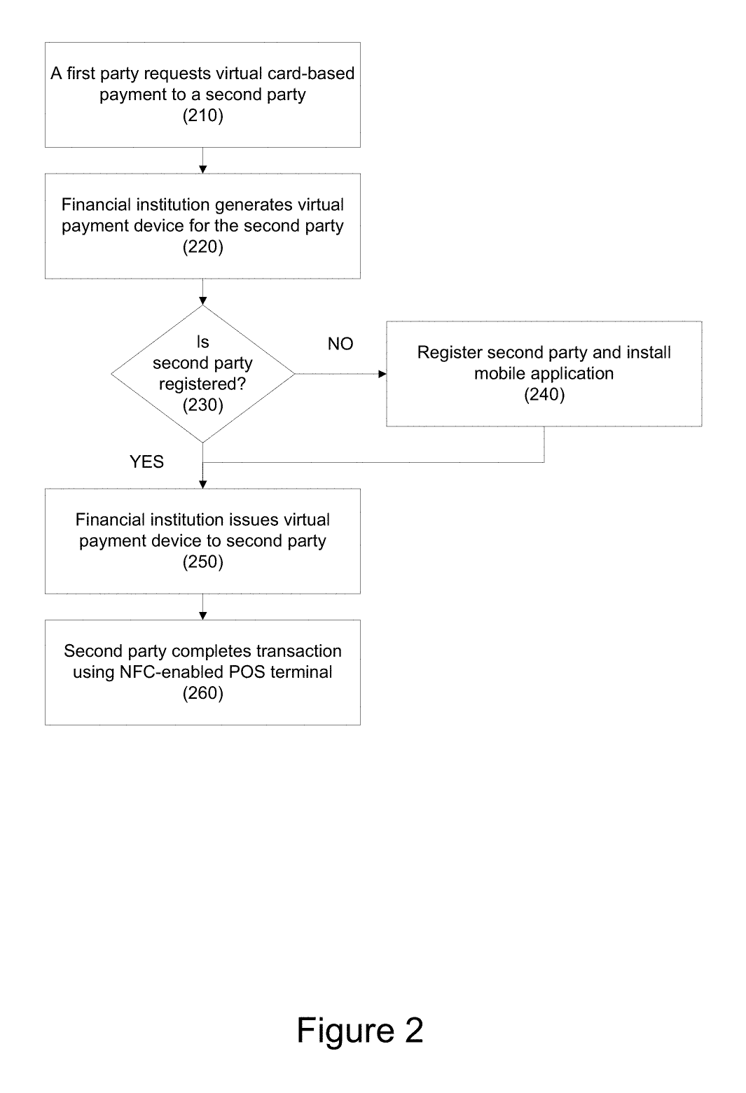

Referring to FIG. 2, a method for delivering a virtual payment device to an electronic wallet according to one embodiment. In step 210, a first party that is a client of a financial institution (e.g., an individual, a business, etc.) may request a virtual payment device-based payment to a second party (e.g., an individual, a merchant, etc.).

In one embodiment, the first party may specify one or more restrictions on the use of the virtual payment device, including, for example, merchant restrictions, good/service restrictions, expiration date, transaction number restrictions, transaction amount restrictions, geographic restrictions, time of day restrictions, etc.

For example, the virtual payment device may have a specific value; any attempts to authorize or use the virtual payment device for a value other than that value may result in the transaction being declined.

In one embodiment, for security purposes, the value of the virtual payment device may not be determined from a review of the virtual payment device.

In step 220, the financial institution may generate a virtual payment device for the second party. In one embodiment, the virtual payment device may be a virtual credit card, a virtual stored value card, a virtual debit card, etc.

In one embodiment, the virtual payment device may comprise a payment token that may be pushed to an electronic wallet.

In one embodiment, any restriction(s) specified by the first party may be added to restrict the use of the virtual payment device.

In step 230, if the second party is not registered with the financial institution, (e.g., does not have an account and/or an electronic wallet application), in step 240, the second party may be invited to register with the financial institution. This may include, for example downloading the electronic wallet application, setting up an account with the financial institution.

In step 250, the financial institution may issue the virtual payment device to the second party. For example, the virtual payment device may be pushed to the second party's electronic wallet application (e.g., using SMS, email, wallet identifier, etc.). As another example, the virtual payment device may be provisioned for the second party's electronic wallet application.

The second party may receive a payment notification and virtual payment device details via the electronic wallet application.

In one embodiment, the electronic wallet application may enforce any restrictions set forth by the first party.

In step 260, the second party may use the virtual payment device to complete a transaction using a point of transaction device. In one embodiment, the transaction may be completed using a NFC-enabled point of sale terminal.

In one embodiment, the point of transaction may be associated with the second party. For example, in the example above, the repair facility may receive the virtual payment device and use its point of transaction device to complete the transaction for the amount money authorized by the automobile insurance provider.

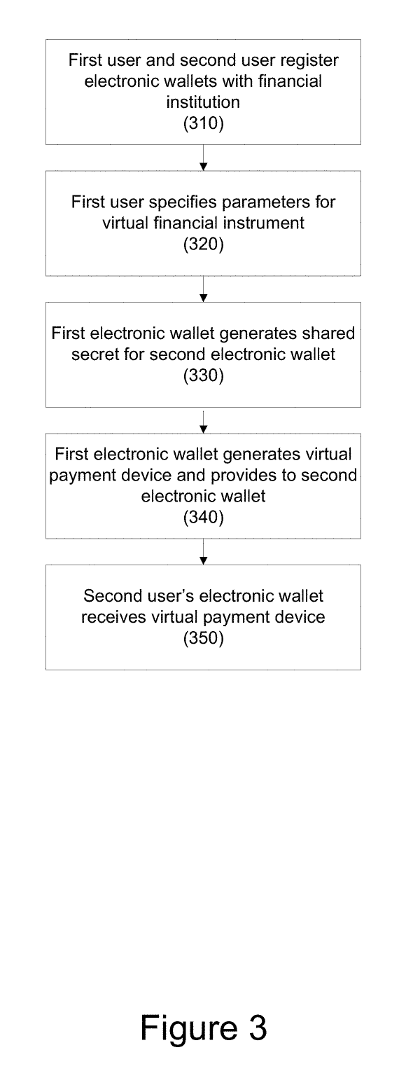

Referring to FIG. 3, a method for provisioning a virtual payment device from a first electronic wallet to a second electronic wallet is provided according to one embodiment. In one embodiment, the virtual payment device, such as a virtual credit card, may be issued as a sub account for an account associated with the first electronic wallet. For example, a parent may issue a virtual credit card to a child, and may specify the amount of credit that the virtual credit card has access to. The amount of credit for the virtual credit card may reduce the credit available to the parent's account.

In one embodiment, the virtual payment device may be a stored value instrument that may be funded from an account in the first electronic wallet. In one embodiment, if all funds are not used after a certain time, they may revert to the account in the first electronic wallet.

In step 310, the first user and the second user may register their respective electronic wallet applications with their respective financial institution. In one embodiment, the financial institutions may be the same; in another embodiment, they may be different.

In step 320, the first user may initiate the process for sending a virtual payment device to the second user. In one embodiment, the first user may set parameters to associate with the virtual payment device, including, for example, specify merchant restrictions, good/service restrictions, expiration date, transaction number restrictions, transaction amount restrictions, geographic restrictions, time of day restrictions, number of use restrictions, etc.

In step 330, the electronic wallet for the first user may generate a shared secret for the second electronic wallet application. For example, the shared secret may be a key, a code, etc. In one embodiment, the electronic wallet for the first user may communicate the shared secret to the electronic wallet for the second user by electronic mail, via the financial institution, directly (e.g., using RF communication, optical communication (e.g., QR codes), etc.).

In step 340, the electronic wallet application for the first user may generate a virtual payment device and communicate the virtual payment device, which may be encrypted using the shared secret, to the second electronic wallet application. In one embodiment, the financial institution for the first user may generate the virtual payment device instead of the electronic wallet.

In one embodiment, the virtual payment device may be pushed by one of the financial institutions to the second user's electronic wallet.

In step 350, the second user's electronic wallet receives the virtual payment device and adds it to the wallet.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for delivering a virtual payment device to an electronic wallet, comprising:
in an information processing device comprising at least one computer processor:
receiving, from a first party, a request to issue a virtual payment device to a second party, the virtual payment device based on an account associated with the first party;
generating the virtual payment device; and
delivering the virtual payment device to an electronic wallet for the second party.

2. The method of claim 1, further comprising:
receiving a transaction from the electronic wallet for the second party with the virtual payment device.

3. The method of claim 2, wherein the transaction was conducted using RF communication.

4. The method of claim 1, further comprising:
receiving, from a point of transaction device associated with the second party, a transaction request using the virtual payment device.

5. The method of claim 1, wherein the virtual payment device comprises a virtual credit card.

6. The method of claim 1, further comprising:
receiving at least one transaction restriction to associate with the virtual payment device.

7. The method of claim 6 wherein the transaction restriction comprises at least one of a merchant restriction, a good/service restriction, an expiration date, a transaction number restriction, a transaction amount restriction, a geographic restriction, and a time of day restriction.

8. The method of claim 1, wherein the virtual payment device comprises a virtual stored value card.

9. The method of claim 1, wherein the step of delivering the virtual payment device to an electronic wallet for the second party comprises provisioning the virtual payment device for the electronic wallet for the second party.

10. The method of claim 1, wherein the step of delivering the virtual payment device to an electronic wallet for the second party comprises pushing the virtual payment device to the electronic wallet for the second party.

11. The method of claim 1, wherein the account is a credit account.

12. The method of claim 1, wherein the account is a deposit account.

13. A method for delivering a virtual credit card to an electronic wallet, comprising:
in an information processing device comprising at least one computer processor:
receiving, from a first party, a request to issue a virtual credit card to a second party, the virtual credit card comprising a portion of a line of credit associated with the first party;
generating the virtual credit card with the portion of the line of credit associated with the first party; and
delivering the virtual credit card to an electronic wallet for the second party.

14. The method of claim 13, further comprising:
receiving a transaction from the electronic wallet for the second party with the virtual credit card.

15. The method of claim 13, further comprising:
receiving at least one transaction restriction to associate with the virtual credit card.

16. The method of claim 15, wherein the transaction restriction comprises at least one of a merchant restriction, a good/service restriction, an expiration date, a transaction number restriction, a transaction amount restriction, a geographic restriction, and a time of day restriction.

17. The method of claim 13, wherein the step of delivering the virtual credit card to an electronic wallet for the second party comprises provisioning the virtual credit card for the electronic wallet for the second party.

18. The method of claim 13, wherein the step of delivering the virtual credit card to an electronic wallet for the second party comprises pushing the virtual credit card to the electronic wallet for the second party.

19. The method of claim 13, wherein the request to issue the virtual credit card to the second party is received from an electronic wallet for the first party.
